(19) United States
(12) Patent Application Publication
(10) Pub. No.: US 2013/0339277 A1
(43) Pub. Date: Dec. 19, 2013

(54) Action-Oriented analytics-driven electronic data identification and labeling

(71) Applicant: Trevor J. Morgan, Leesburg, VA (US)

(72) Inventor: Trevor J. Morgan, Leesburg, VA (US)

(73) Assignee: Fastline Technologies, LLC, Vienna, VA (US)

(21) Appl. No.: 13/573,384

(22) Filed: Sep. 13, 2012

Related U.S. Application Data
(60) Provisional application No. 61/535,383, filed on Sep. 16, 2011.

(51) Int. Cl. G06N 99/00

(52) U.S. Cl. CPC G06N 99/005
USPC 706/12

(57) ABSTRACT

A corporate compliance/document retrieval system and method for enabling automated software inspection of textual documents based upon seeding the software with examples of categories of interest. The system enables resultant actions such as breach dismissals, breach escalations, closer inspection of an offender's communications, and iterative machine learning when specific content is detected that is representative of a category of interest. The alerting breaches occur in near real time and can alleviate further breaches from occurring.

### DOMESTIC PRIORITY

This application claims the benefit of the filing date for Provisional Application No. 61/535,383, filed Sep. 16, 2011.

### BACKGROUND OF THE INVENTION

1. Field of the Invention

This invention relates to an advanced analytical method to search the textual content of documents.

2. Description of the Prior Art

The very first U.S. patent, signed by President George Washington, was issued to Samuel Hopkins on Jul. 31, 1790, for a process of making potash and pearl ash as an ingredient for soap manufacture. This is not that patent. Technology has advanced in a multitude of ways for a broad range of fields to include the field of document searching. One can only imagine that in 1790, when Samuel Hopkins was preparing his patent application, his search for relevant prior art consisted of reviewing whatever documents he could read, and looking for such key words as “potash” or “pearl ash.” At some point in time, this search process advanced to where the actual search was conducted using computer technology. Ultimately, however, once the search was completed, a human being, the same as in the case of Samuel Hopkins, would have to review the search results to determine relevancy or what, if any further action would be necessary in connection with the search.

The necessity to search documents for content exists not just for relevant prior art in connection with patentability but for a plethora of reasons to include for litigation purposes as well as to insure corporate compliance with Federal, State or local laws. While the documents and the content therein, needed to be searched by Mr. Hopkins might have only been books he could find, in today's tech savvy environment, these documents and their content come in many different forms such as emails, word processing documents, facsimiles, PDF files, JPEG images, Twitter messages, text messages, or Facebook posts. In 1790, the documents to be search might be located in a library. Today, those documents can exist on various platforms such as desktop computers, laptop computers, flash drives, external hard drives, smart-phones, or IPADs; located locally, in a cloud based environment or archived. To search for textual content, all of the different types of documents on all the various platforms in the many repositories must be searched and channeled to a human being to determine relevancy and if further action is warranted. The task is monumentally time consuming, and can be arbitrary considering a human being must read and interpret text, at least until the advancements disclosed herein.

Whether responding to document requests in a litigation context, or in determining corporate compliance with Federal laws, internal and external rules and regulations most always indicate that certain actions need to be performed when documents containing a specific conceptual content are encountered. For example, if an internal document breaks SEC mandated regulations for publically traded companies, an entire escalatory action chain must be initiated to avoid adverse governmental measures.

### SUMMARY OF THE INVENTION

It is, therefore, an object of the present invention to solve both of the aforementioned problems by first effectively ascertaining the conceptual content in a document or electronic data and then providing an automated means to proactively carry [symbol] Other objects and advantages of the present invention will become apparent from the following detailed description when viewed in conjunction with the accompanying drawings, which set forth certain embodiments of the invention.

### BRIEF DESCRIPTION OF THE DRAWINGS

FIG. 1 is a schematic of the typical workflow of documents entering and/or leaving a corporate environment, as well as archival of some or all of that data

FIG. 2 is a schematic of the proposed method by which analytics software is trained to recognize specific types of contextual content within a corporate documents and then to carry out one or more actions based upon the content encountered.

### DESCRIPTION OF THE PREFERRED EMBODIMENTS

The detailed embodiments of the present invention are disclosed herein. It should be understood, however, that the disclosed embodiments are merely exemplary of the invention, which may be embodied in various forms. Therefore, the details disclosed herein are not to be interpreted as limiting, but merely as the basis for the claims and as a basis for teaching one skilled in the art how to make and/or use the invention.

The present invention, which is a method for action-oriented analytics driven electronic data labeling resolves the issues of carrying out action chains when conceptuality with a document is detected by combining advanced analytics technology (conceptual analytics software) with an intuitive application lawyer allowing the operator to perform the following:
1. Answer questions presented by the software in an effort to seed the analytics engine with enough conceptual information so that it can detect variations of that conceptual content as it inspects the streams of electronic data. This makes the machine learning aspect of the analytics engine palatable and easy to use, as well as insures the precision of the analytics engine. In essence, the operator or user answers questions or specifies text without even necessarily knowing that the software is learning from the human responses what is conceptually interesting to the user.
2. Establish one or more actions (an action chain) which the software can automatically carry out upon encountering conceptual content as it inspects all electronic data. The operator or user can influence the action chain upon identification of specific content, but the action chain is preset and is triggered by detection of conceptual content. These actions can be well identified and are part of the hard coded processes of the system. The fundamental actions include dismissing the breach upon human inspection, escalation of the breach to a human higher up in the organizational chart, setting thresholds on the person committing the breach so that communications are watched at a closer level or using the breach to further inform the analytics software about interesting content to look for.

The exemplary embodiment relates to a suite of automation software consisting of advanced analytics and workflow logic which allows for both real time and reactive monitoring and analysis of textual data within a corporation or organization. The advanced analytics software, which may employ linguistic, probabilistic, mathematical, heuristic, or any combination of indexing technologies, is capable of detecting conceptual content within textual data. Furthermore, the advanced analytics software, working in tandem with the wrapper of workflow and user interface software, allows for; human seeding of the advanced analytics engine without requiring human understanding of taxonomy development; for analysis of electronic data which the advanced analytics engine identifies and labels as interesting conceptual content; for near real time alerting to configured users when breaches occur; and for initiating action chains including but not solely relegated to further seeding of the advanced analytics engine, more granular monitoring of data deriving from specified custodians, and analysis escalation.

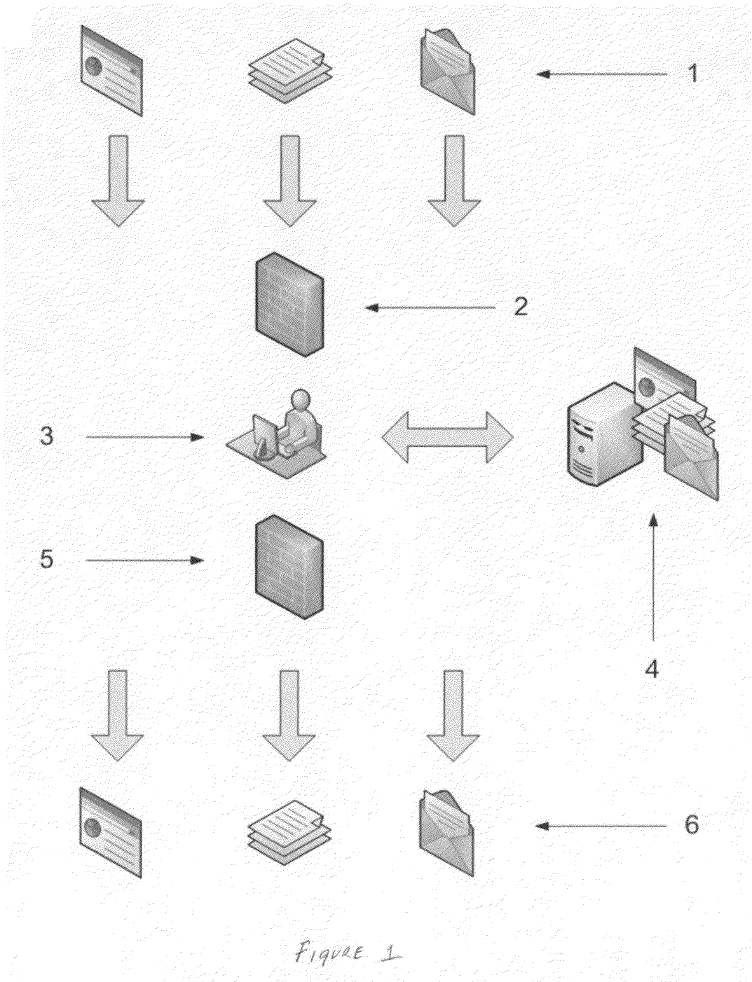

In FIG. 1, and electronic data stream [1] consisting of web based traffic, electronic data transmissions (social networking interactions), and/or emails, is represented ingressing a corporation or organization through the networked boundary [2]. The electronic data is being consumed (accessed,. Read, forwarded, and/or stored) by corporate or organizational personnel [3] utilizing electronic resources such as laptops, workstations, servers, storage drives and appliances, and electronic archives [4].

Egressing electronic data stream [6] across organizational boundary [5] can be a combination of data ingressing the corporation [1] and electronic data created within the corporation or organization, or egressing electronic data stream [6] can consist entirely of electronic data originating within the corporation or organization.

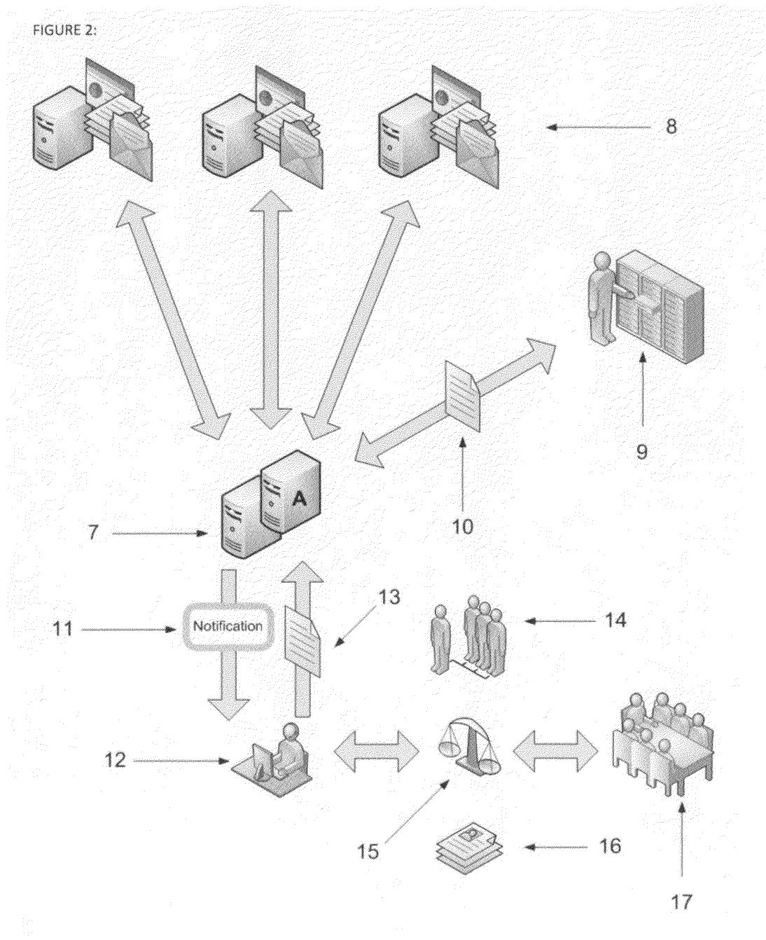

FIG. 2 displays servers running advanced analytics and workflow software [7] which can be configured to connect via TCP/IP networks or corporate or organizational data sets traversing or residing on electronic resources such as laptops, workstations, servers, storage drives and appliances, and electronic archives [8]. Serves can monitor the electronic resources [8] in real time (dynamically) as electronic data streams across these electronic resources [8] or after the fact (statically) in the case of stored or archived information.

The advanced analytic method of the present invention [7] can utilize a linguistic, probabilistic, mathematical or heuristic indexing scheme to analyze the textual data to derive conceptuality within all text documents. An operator or administrator [9] carries out the initial seeding of the fo the analytics search engine with conceptual content [10] which is of particular interest to the corporation or organization. Conceptual content of interest [10] can come from a variety of sources such as corporate, organizational, industry, or regulatory data, organized into idiosyncratic or industry standard hierarchies of categories. Additionally, the advance analytics software [7] can allow an operator or administrator [9] to perform concept search, concept clustering, or conceptual term expansion across any electronic data source [8] in order to locate further examples of interesting conceptual content [10]. Conceptual content [10] seeds the analytics software [7] which adjusts based upon its machine learning algorithms to better detect the type of conceptual content from the electronic data sources [8] to identify and label during monitoring.

Workflow software responds to identified and labeled conceptual content with alerts and notifications [11] which are reviewed, analyzed and assessed by corporate or organizational personnel [12]. Personnel [12] can instantiate an automatic action chain [13] configured by operator or administrator [9], consisting of providing further conceptual content to the advanced analytics software [7] so that said software is more nuanced and accurate in its understanding of interesting conceptual content [10] for which to monitor. Other pre-programmed and automated action chains include more closely watching identified data and who consumes that data internally; escalating notifications, alerts and watches to higher tiers of management [14], legal counsel [15], human resources [16] and executive management [17; and ultimately taking proactive measures to ensure further data containing identified and labeled conceptual content does not egress the organization. Additional action chains include applying labels or codes to identified date for further internal processing.

While the preferred embodiments have been shown and described, it will be understood that there is no intent to limit the invention by such disclosure, but rather, is intended to cover all modifications and alternate constructions falling within the spirit and scope of the invention as defined in the appended claims.

1. A method for seeding advanced analytics software so that the software understands the conceptuality of one or more categories of interest.

2. The method of claim 1 further comprising the accommodation of one or more actions to be carried out by an operator upon automatic detection of content matching one or more categories of interest.

3. The method of claim 2 wherein the actions include dismissal of the breach, escalation of the breach, reduction of threshold for the offender so that more communications are automatically examined by the method, or using the breach to further clarify for the analytics software what the conceptuality of a category.

3. The method of claim 2 further comprising automated software inspection of textual data entering, leaving or being stored on corporate servers.

4. The method of claim 2 further comprising automatic identification of documents that match a configured category of interest.

5. The method of claim 2 further comprising notification to one or more users who are configured to receive said notifications.

6. The method of claim 5 further comprising enabling the user who receives the notification of a breach to examine the contents and context of the breach, dismiss the breach, escalate the breach to another user, reduce the analytics threshold so that more communications from the offender are examined or using the breach to further refine the analytics software's understanding of a category of interest.

7. The method of claim 5 further comprising tracking/logging of all user interactions with the method and generation of reports concerning compliance breaches and/or relevant document/data as well as the resultant action taken thereon.
